(19) United States
(12) Patent Application Publication
(10) Pub. No.: US 2014/0290425 A1
(43) Pub. Date: Oct. 2, 2014

(54) Pedal Assembly with Mounting Insert

(71) Applicant: Murray Kaijala, Elkhart, IN (US)

(72) Inventor: Murray Kaijala, Elkhart, IN (US)

(73) Assignee: CTS CORPORATION, Elkhart, IN (US)

(21) Appl. No.: 14/222,750

(22) Filed: Mar. 24, 2014

Related U.S. Application Data
(60) Provisional application No. 61/806,068, filed on Mar. 28, 2013.

(51) Int. Cl. G05G 1/44

(52) U.S. Cl. CPC G05G 1/44
USPC 74/512

(57) ABSTRACT

A vehicle pedal assembly comprising a housing for a pedal, the housing being made of a molded plastic material and including a mounting flange with a nut type metal mounting insert that has been insert molded into the plastic material. In one embodiment, the mounting insert is a T-nut type including a radial collar with a plurality of tabs each terminating in a distal barb. In one embodiment, the distal barb is rounded and insert molded into the plastic material of the mounting flange and in another embodiment the distal barb is arrow-shaped and press-fitted into a slot defined in the mounting flange. In another embodiment, the mounting insert is a slotted flange T-nut type.

### CROSS REFERENCE TO RELATED AND CO-PENDING APPLICATION

This application claims the benefit of the filing date and disclosure of U.S. Provisional Patent Application Ser. No. 61/806,068 filed on Mar. 28, 2013, the contents of which are entirely incorporated herein by reference as well as all references cited therein.

### FIELD OF THE INVENTION

The present invention relates generally to a vehicle pedal assembly and, more specifically, to a mounting insert for an accelerator pedal assembly.

### BACKGROUND OF THE INVENTION

Accelerator pedal assemblies include pedal housings with mounting flanges that incorporate metal inserts adapted to receive screws or bolts that mount the pedal assembly to a vehicle mounting bracket which, in turn, mounts the pedal assembly to the floor of a vehicle.

The present invention is directed to a pedal assembly with an improved and lower cost metal mounting insert.

SUMMARY OF THE INVENTION

The present invention is generally directed to a vehicle pedal assembly comprising a housing for a pedal made of a molded plastic material, the housing including a mounting flange with a nut type mounting insert that has been insert molded into the plastic material of the mounting flange.

In one embodiment, the mounting insert is a T-nut type mounting insert including an interiorly threaded elongate sleeve and a radial collar with a plurality of tabs.

In one embodiment, the plurality of tabs depend downwardly from the radial collar in a relationship spaced and generally parallel to the sleeve and the longitudinal axis of the mounting insert and terminate in a rounded distal barb.

In one embodiment, the plurality of tabs depend downwardly from the radial collar in a relationship spaced and generally parallel to the sleeve and the longitudinal axis of the mounting insert and terminate in an arrow-shaped distal barb.

In one embodiment, the mounting insert is a slotted flange type nut wherein the radial collar includes a plurality of tabs and slots extending around the sleeve of the mounting insert in an alternating relationship.

In one embodiment, the mounting insert is a hex nut type mounting insert wherein the sleeve of the mounting insert is in the form of an interiorly threaded hex nut including first and second interiorly threaded collars extending outwardly from the respective distal end faces of the hex nut.

The present invention is also directed to a vehicle pedal assembly comprising a pedal housing made of a molded plastic material and including a mounting flange with a mounting insert, the mounting insert including a threaded sleeve extending into the mounting flange and a radial collar on the sleeve with a plurality of elongate tabs extending into the mounting flange for securing the mounting insert to the mounting flange of the pedal housing.

In one embodiment, the mounting insert is insert molded into the plastic material of the mounting flange, the plurality of tabs extending downwardly from the collar in a relationship spaced and parallel to the sleeve and the longitudinal axis of the mounting insert and terminating in a rounded distal barb.

In one embodiment, the mounting flange of the pedal housing defines a through-hole, a recess surrounding the through-hole, and a plurality of slots surrounding and spaced from the through-hole and extending in a direction normal to the opposed exterior surfaces of the mounting flange, the sleeve and the collar and the plurality of tabs of the mounting insert being press-fitted into the respective through-hole and the recess and the plurality of slots respectively in the mounting flange of the pedal housing for securing the mounting insert in the mounting flange of the pedal housing.

In one embodiment, the plurality of tabs extend downwardly from the collar of the mounting insert in a relationship spaced and parallel to the sleeve and the longitudinal axis of the mounting insert and terminate in an arrow-shaped distal barb that is press-fitted into a slot defined in the mounting insert.

Other advantages and features of the present invention will be more readily apparent from the following detailed description of the preferred embodiments of the invention, the accompanying drawings, and the appended claims.

### BRIEF DESCRIPTION OF THE DRAWINGS

These and other features of the invention can best be understood by the following description of the accompanying FIGURES:

FIG. 1 is a perspective view of a pedal assembly in accordance with the present invention mounted to the floor of a vehicle via a mounting bracket;

FIG. 2 is a perspective view of the housing of the pedal assembly shown in FIG. 1 including one embodiment of a mounting insert in accordance with the present invention;

FIG. 3 is an enlarged perspective view of the mounting insert of the pedal assembly shown in FIGS. 1 and 2;

FIG. 4 is a broken, part side elevational view, part vertical cross-sectional view taken through one of the housing mounting flanges and mounting inserts of the housing of the pedal assembly shown in FIG. 1;

FIG. 5 is a perspective view of another embodiment of a pedal assembly housing a including another embodiment of a mounting insert in accordance with the present invention;

FIG. 6 is a broken exploded perspective view of the pedal assembly housing and mounting insert shown in FIG. 5;

FIG. 7 is an enlarged perspective view of the mounting insert of the pedal assembly housing shown in FIGS. 5 and 6;

FIG. 8 is a broken, part side elevational view, part vertical cross-sectional view taken through one of the mounting flanges and mounting inserts of the pedal assembly housing shown in FIG. 5 with the pedal assembly housing mounted to the mounting bracket shown in FIG. 1;

FIG. 9 is a perspective view of a further embodiment of a pedal assembly housing including a further embodiment of a mounting insert in accordance with the present invention;

FIG. 10 is an enlarged perspective view of the mounting insert of the pedal assembly housing shown in FIG. 9;

FIG. 11 is broken, part side elevational view, part vertical cross-sectional view taken through one of the mounting flanges and mounting inserts of the pedal assembly housing shown in FIG. 9 with the pedal assembly housing mounted to the mounting bracket shown in FIG. 1;

FIG. 12 is a perspective view of a still further embodiment of a pedal assembly housing with yet a further embodiment of a mounting insert in accordance with the present invention;

FIG. 13 is an enlarged perspective view of the mounting insert of the pedal assembly housing shown in FIG. 12; and

FIG. 14 is a broken, part side elevational view, part vertical cross-sectional view taken through one of the mounting flanges and mounting inserts of the pedal assembly housing shown in FIG. 12 with the pedal assembly housing mounted to the mounting bracket shown in FIG. 1.

### DETAILED DESCRIPTION OF THE EMBODIMENTS

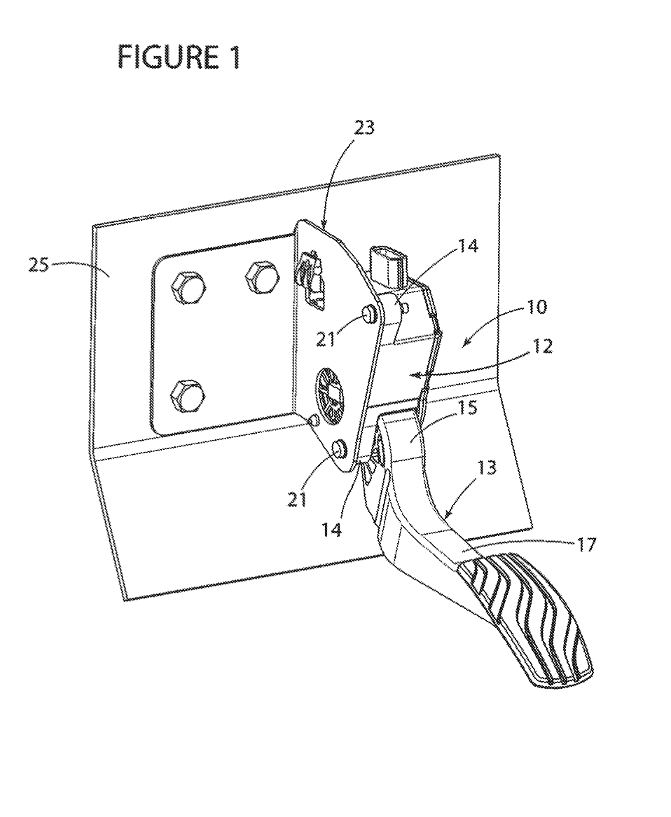

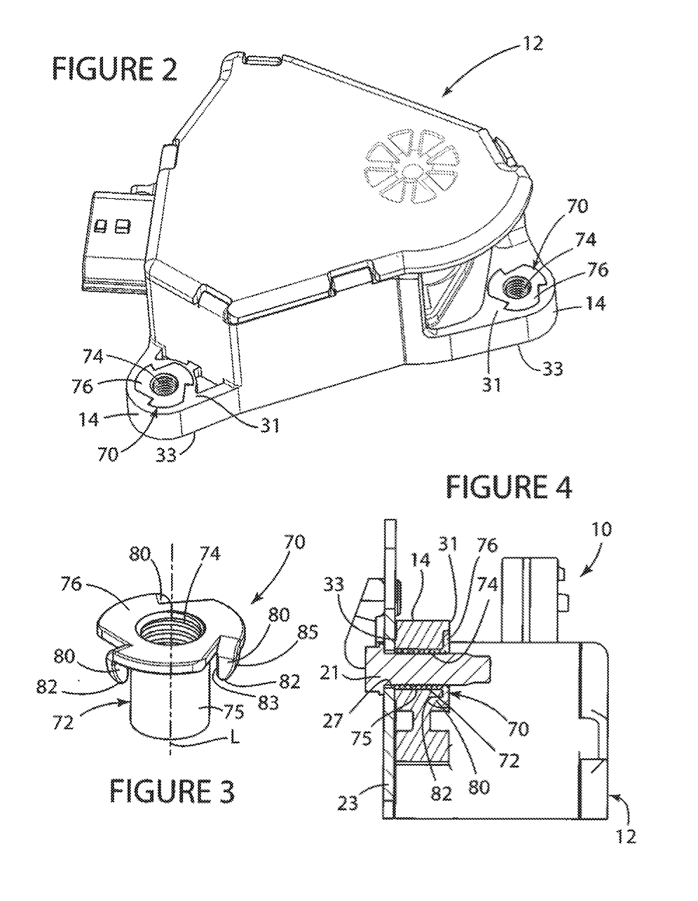

FIGS. 1-4 depict a vehicle pedal assembly 10 with one embodiment of a T-nut type mounting insert 70 (FIGS. 2, 3, and 4) in accordance with the present invention.

The vehicle pedal assembly 10 is comprised of a pedal housing 12 that includes a plurality, and in the embodiment shown a pair, of outwardly protruding and extending mounting flanges or arms 14. An elongate pedal 13 (FIG. 1) is rotatably supported in the pedal housing 12. The pedal 13 includes a drum 15 that extends into the Interior of the pedal housing 12 and is mounted in the pedal housing 12 for rotation relative to the pedal housing 12. An external and elongate pedal arm 17 extends from the drum 15 of the pedal 13 and is adapted for clockwise depression and rotation to cause the acceleration of the vehicle and counter-clockwise movement and rotation to cause the deceleration of the vehicle. FIG. 1 shows the pedal 13 in its idle position. Both the pedal housing 12 and the pedal 13 may be made of a suitable molded plastic material.

The T-nut type mounting insert 70 (FIGS. 2-4) is located and secured in each of the mounting flanges 14 as by, for example, insert molding into the plastic material that forms and defines each of the mounting flanges 14 of the pedal housing 12 during the manufacture and molding of the pedal housing 12.

A mounting screw or bolt 21 (FIGS. 1 and 4) extends and is threaded through each of the mounting inserts 70 and thus through each of the mounting flanges 14 for clipping, mounting, and securing the pedal housing 12, and thus the pedal assembly 10, to a generally L-shaped bracket 23 (FIGS. 1 and 4) which, in turn, is mounted and secured to the floor board 25 (FIG. 1) of a vehicle.

As shown in more detail in FIGS. 2-4, each of the mounting inserts 70, which is preferably made of a suitable metal material including for example a steel. Zinc, and Chrome alloy, includes an elongate and generally cylindrically and tubular shaped central elongate hollow base or sleeve 72 that includes a circumferentially extending exterior surface 75 and a threaded circumferentially extending interior surface 74 that defines a generally cylindrically shaped interior through-hole extending through the length of the base or sleeve 72 and terminates and defines respective openings in the opposed distal ends of the base or sleeve 72,

A collar or flange or rim 76 extends radially outwardly from a top or distal peripheral edge of the exterior surface 75 of the base or sleeve 72 of the mounting insert 70. In the embodiment shown, the collar or flange or rim 76 extends around the full circumference of the exterior surface 75 of the base or sleeve 72 of the mounting insert 70 in a relationship and direction generally normal to the central longitudinal axis L of the mounting insert 70.

The collar or flange or rim 76 includes three elongate tabs or prongs 80 that project and extend unitarily generally normally downwardly from the outer peripheral edge of the collar 78. In the embodiment shown, each of the tabs 80 terminates in a rounded distal end or barb 82 including for example a radius of R 0.6 and the tabs 80 extend around the collar 78 in a spaced-apart and parallel relationship to each other, the exterior surface 75 of the sleeve 72 of the mounting insert 70, and the longitudinal axis L of the mounting insert 70. In the embodiment shown, the tabs 80 are spaced at one hundred twenty degree (120°) intervals and extend a length from the collar 76 which is approximately between one third (⅓) and one half (½) the length of the sleeve 72.

In the embodiment shown, each of the tabs or prongs 80 includes a generally straight elongate interior or inner side surface 83 that extends in a relationship parallel and spaced from the longitudinal axis L of the mounting insert 70, in a relationship opposed and spaced from the exterior surface 75 of the base or sleeve 72, and terminates in the interior or inner edge of the rounded distal end or barb 82. Each of the tabs or prongs 80 also includes an elongate exterior or outer side surface 85 that is spaced from and opposed to the interior side surface 83, curves inwardly from the collar 78 in the direction of the base or sleeve 72, and terminates in the exterior or outer edge of the rounded distal end or barb 82.

In the embodiment shown, each of the tabs or prongs 80 is comprised of a peripheral portion or region of the collar 78 which has been cut away from the collar 78 and subsequently bent down and away from the collar 78 and into an orientation and relationship generally normal to the collar 78 and generally parallel to and spaced and opposite from the exterior surface 75 of the sleeve 72 and the longitudinal axis L of the mounting insert 70. Moreover, in the embodiment shown, each of the tabs or prongs 80 is oriented relative to the sleeve 72 and the collar 76 in a relationship wherein the vertical plane of the tabs or prongs 80 extend through the longitudinal axis L of the mounting insert 70. Further, in the embodiment shown, the collar 76 when viewed from the planar perspective of FIG. 2, is generally in the form and shape of a serrated circular saw blade.

Each of the mounting inserts 70 is, during the process of molding the pedal housing 12, insert molded into the plastic material that comprises and forms each of the respective mounting flanges 14 of the pedal housing 12 into a position and relationship in each of the respective mounting flanges 14 as shown in FIG. 4 wherein: the sleeve 72 of the mounting insert 70 extends through the interior of the mounting flange 14 in a direction and orientation generally normal to the opposed exterior surfaces 31 and 33 of the mounting flange 14; the exterior surface of the collar 76 of the mounting insert 70 is even or flush with the exterior surface 31 of the mounting flange 14; the exterior radial surface of the distal end of the sleeve 72 opposite the distal end of the sleeve 72 with the collar 76 is even or flush with the opposed exterior surface 33 of the mounting flange 14; and the tabs or prongs 80 extend from the collar 76 into the interior of the mounting flange 14 and, more specifically into the plastic material that comprises and forms the mounting flange 14, in the direction of the exterior surface 33 of the mounting flange 14 and more specifically in an orientation and relationship generally normal to the opposed exterior surfaces 31 and 33 of the mounting flange 14.

In the embodiment shown, the mounting insert 70 is insert molded into the plastic material of the mounting flange 14 in a relationship and orientation wherein the distal radial end of the sleeve 72 without the collar 76 is located opposite and abutting against the exterior surface of the vehicle pedal assembly mounting bracket 23 and further in a relationship wherein the tabs or prongs 80 of the mounting insert 70 extend in the direction of, and in a relationship generally normal to, the pedal assembly mounting bracket 23.

The respective pedal assembly mounting screws 21 are inserted successively through respective through-holes 27 (FIG. 4) in the pedal assembly bracket 23 and then threaded into each of the respective mounting inserts 70 in each of the respective mounting flanges 14 for mounting and securing the pedal housing 12 and thus the pedal assembly 10 to the pedal assembly bracket 23 and thus mounting the pedal assembly 10 to the floor board 25 of the vehicle as shown in FIG. 1.

In accordance with the present invention, the use of a mounting insert 70 including tabs or prongs 80 with rounded distal ends advantageously reduces stress concentrations in the encapsulating plastic material that surrounds the mounting insert 70 and forms the mounting flange 14, By reducing the stress concentrations, there is a lower likelihood of the plastic material cracking at extreme temperature conditions and also a corresponding increase and improvement in the torsional and axial retention characteristics of the mounting insert 70 in the mounting flange 14.

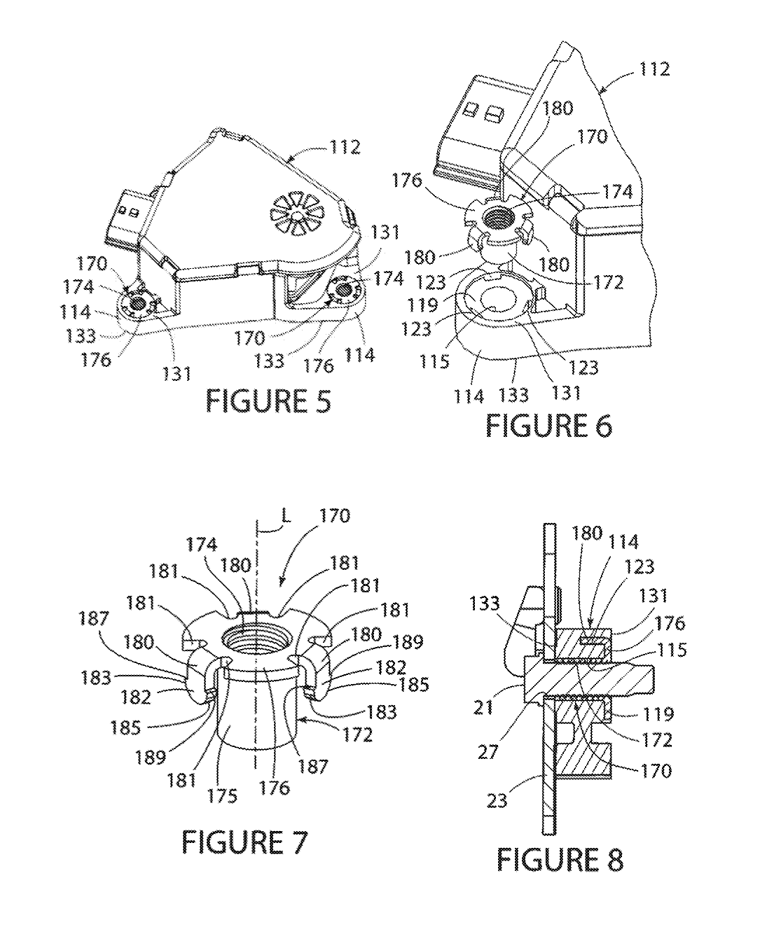

FIGS. 5, 6, 7, and 8 depict a vehicle pedal assembly housing embodiment 112 that incorporates another embodiment of a T-nut type mounting insert 170 in accordance with the present invention.

The pedal assembly housing 112 is identical in structure to the pedal assembly housing 12 with the exception of the structure of the mounting flanges 114 and the mounting inserts 170 and is adapted to be mounted and secured to the pedal assembly mounting bracket 23 in the same manner as the pedal assembly housing 12 and thus the earlier description of the elements of the pedal assembly housing 12, the pedal assembly 10, and the mounting bracket 23 is incorporated herein by reference with respect to the pedal assembly housing 112.

In the embodiment of the pedal housing 112 as shown in FIGS. 6 and 8, each of the outwardly protruding mounting flanges or arms 114 defines a generally cylindrically-shaped interior through-hole 115 that defines respective openings in the opposed exterior upper and lower surfaces 131 and 133 of each of the respective flanges 114.

Each of the mounting flanges 114 additionally includes a recessed surface 119 which is parallel and spaced from the exterior surface 131 of the flange 114 and defines a generally circular recess in the exterior upper surface 131 of the flange 114. In the embodiment shown, the one of the openings defined by the through-hole 115 terminates in the recessed surface 119.

A plurality of slots 123 are defined in and extend from the recessed upper surface 119 into the body of the mounting flange 114 in a relationship and orientation generally normal to the exterior opposed upper and lower surfaces 131 and 133 of the mounting flange 114, in the embodiment shown, three slots 123 extend circumferentially around the openings defined by the through-hole 115 at one hundred twenty degree (120°) intervals in a spaced-apart and generally parallel relationship relative to each other and the through-hole 115.

As shown in more detail in FIG. 7, the mounting insert 170, which is preferably made of a suitable metal material including for example a steel, Zinc, and Chrome alloy, includes an elongate and generally cylindrically and tube shaped hollow base or sleeve 172 that includes a circumferentially extending exterior surface 175 and a threaded interior surface 174 that defines a generally cylindrically shaped interior through-hole extending through the length of the base or sleeve 172 and terminates in and defines respective openings in the opposed distal ends of the base or sleeve 172.

A collar or flange or rim 176 extends radially outwardly from a top or distal peripheral edge of the exterior surface 175 of the sleeve 172 of the mounting insert 170. In the embodiment shown, the collar or flange or rim 176 extends circumferentially around the distal peripheral edge of the exterior surface 175 of the base or sleeve 172.

In the embodiment shown, the collar 176 includes three elongate tabs or prongs 180 that project and extend unitarily generally normally downwardly from a peripheral exterior distal edge of the collar 176. In the embodiment shown, each of the tabs or prongs 180 terminates in a downwardly pointing arrow-shaped distal end or barb 182 and the tabs 180 extend around the collar 178 in a spaced-apart and parallel relationship to each other, the exterior surface 175 of the sleeve 172 of the mounting insert 170, and the longitudinal axis L of the mounting insert 170. In the embodiment shown, the tabs 180 are spaced at one hundred twenty degree (120°) intervals from each other and have a length of approximately one half (½) the length of the sleeve 172.

Moreover, in the embodiment shown, the proximal end of each of the tabs or prongs 180 unitary with the peripheral edge of the collar 178 extends between a pair of slits or slots 181 defined in and extending from the peripheral exterior edge of the collar 178 and into the body of the collar 178.

Moreover, the arrow-shaped distal end or barb 182 on each of the tabs or prongs 180 includes a pair of distal and diametrically opposed exterior sloped camming surfaces 183 and 185 and a pair of opposed and diametrically opposed horizontal and flat shoulders 187 and 189.

As shown in FIGS. 5 and 8, each of the mounting inserts 170 is adapted to be press-fitted into the plastic material of each of the respective mounting flanges 114 of the pedal housing 112 into a position and relationship wherein: the base or sleeve 172 of the mounting insert 170 extends and is press-fitted into the interior of the through-hole 115 defined in each of the respective flanges 114 and extends in a relationship and direction generally normal to the opposed exterior surfaces 131 and 133 of the mounting flange 114; the collar 176 of the mounting insert 170 is press-fitted into the recess 119 defined in each of the respective flanges 114 and is positioned in a relationship wherein the exterior surface of the collar 176 is even or flush with the exterior surface 131 of the mounting flange 114; the distal end of the base or sleeve 172 opposite the distal end thereof with the collar 176 is positioned in a relationship even or flush with the opposed exterior surface 133 of the mounting flange 114: and the tabs 180 on the collar 178 are press-fitted into the respective slots 123 defined in each of the respective flanges 114 with the arrow-shaped distal ends or barbs 182 pointing in the direction of the exterior surface 133 of the mounting flange 114.

In accordance with the present invention, the exterior sloped camming surfaces 183 and 185 defined on the distal barb 182 of each of the tabs or prongs 180 are designed to guide the respective tabs or prongs 180 into and through the respective slots 123 when the respective mounting inserts 170 are press-fitted into the respective mounting flanges 114 and the exterior shoulders 187 and 189 defined on the distal barb 182 of each of the tabs or prongs 180 are designed to be surrounded by the plastic material of the respective mounting flanges 114 and prevent the respective mounting inserts 170 from being pulled out of or from coming out of the respective mounting flanges 114 after the respective mounting inserts 170 have been press-fitted into the respective mounting flanges 114.

In the embodiment shown, the tabs 180 are oriented relative to the sleeve 172 and the collar 176 of the mounting insert 170 in a relationship wherein the vertical plane of the tabs 180 is spaced and generally parallel to the longitudinal axis L of the sleeve 172 of the mounting insert 170.

Alternatively, each of the mounting inserts 170, like the mounting inserts 70, may be insert molded into the plastic material forming each of the respective mounting flanges 114.

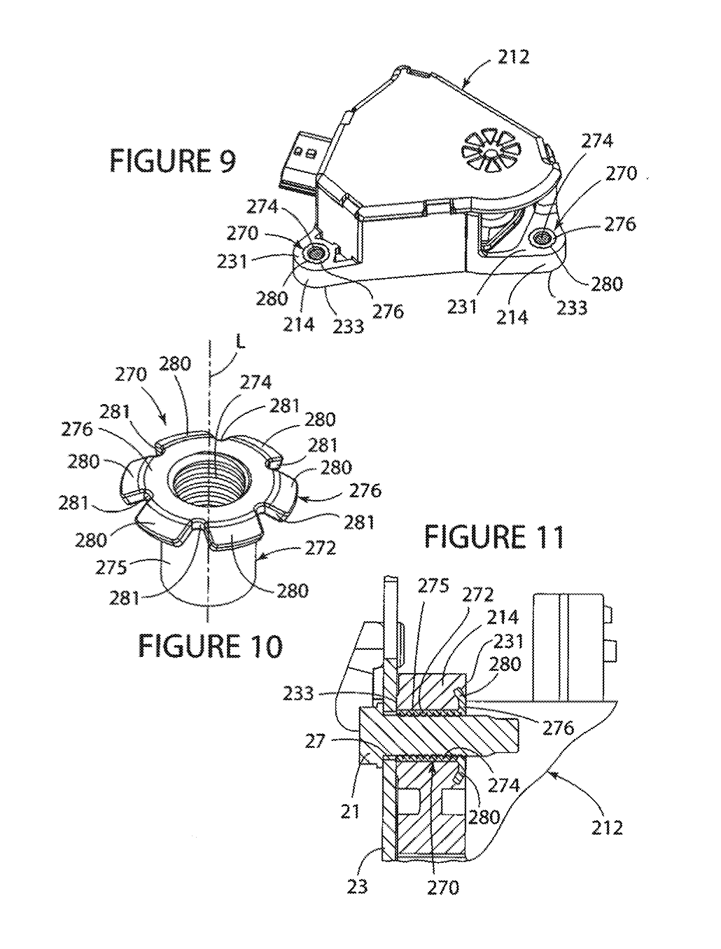

FIGS. 9-11 depict a vehicle pedal assembly housing 212 with another embodiment of a slotted flange 1-nut type mounting insert 270 in accordance with the present invention.

The pedal assembly housing 212 is identical in structure to the pedal assembly housing 12 with the exception of the structure of the mounting inserts 270 and is adapted to be mounted and secured to the pedal assembly mounting bracket 23 in the same manner as the pedal assembly housing 12 and thus the earlier description of the elements of the pedal assembly housing 12, the pedal assembly 10, and the mounting bracket 23 is incorporated herein by reference with respect to the pedal assembly housing 212.

Specifically, the pedal assembly housing 212 comprises a housing for the pedal 13 and includes a plurality of outwardly protruding mounting flanges or arms 214. The mounting insert 270 is located and secured in each of the flanges 214 in the same manner as described above with respect to the mounting insert 70 and thus incorporated herein by reference including specifically and as by, for example, insert molding during the forming and manufacturing process into the plastic material forming and defining each of the mounting flanges 214.

As shown in more detail in FIG. 10, the mounting insert 270, which is preferably made of a suitable metal material including for example a steel, Zinc, and Chrome alloy, includes an elongate and generally cylindrically or tube shaped hollow central base or sleeve 272 that includes an exterior circumferential surface 275 and a threaded interior surface 274 that defines a generally cylindrically shaped interior through-hole extending through the length of the base or sleeve 272 and terminating in and defining respective openings in the opposed distal ends of the base or sleeve 272.

A collar or flange or rim 276 extends radially outwardly from a top peripheral distal edge of the exterior surface 275 of the base or sleeve 272 of the mounting insert 270. In the embodiment shown, the collar or flange or rim 276 extends around the full circumference of the exterior surface 275 of the base or sleeve 272 of the mounting insert 270 and extends in a direction generally normal to the central longitudinal axis L of the mounting insert 270.

The collar or flange 276 includes a plurality of tabs 280 that project and extend unitarily generally outwardly from the collar 276 and are defined by a plurality of slits or slots 281 defined in the collar or flange 276. In the embodiment shown, the tabs 280 and slots 281 extend on the collar 276 and around the circumference of the top peripheral distal edge of the exterior surface 275 of the base or sleeve 272 in an alternating and spaced apart relationship and direction generally normal to the longitudinal axis L of the mounting insert 270.

Moreover, in the embodiment shown, each of the tabs 280 projects and slopes both outwardly and downwardly away from the exterior surface 275 of the base or sleeve 272 and the collar 276 of the mounting insert 270 and each of the slits or slots 281 defined in the collar or flange 276 is generally V-shaped.

Each of the mounting inserts 270 is insert molded into the plastic material of each of the respective mounting flanges 214 of the pedal housing 212 into a position and relationship in each of the respective mounting flanges 214 as shown in FIG. 11 wherein: the base or sleeve 272 of the mounting insert 270 extends through the interior of the flange 214 in a direction generally normal to the opposed exterior surfaces 231 and 233 of the mounting flange 214; the exterior surface of the collar 276 of the mounting insert 270 is even or flush with the exterior surface 231 of the mounting flange 214; the distal radial end face of the base or sleeve 272 opposite the distal end thereof with the collar 276 is even or flush with the opposed exterior surface 233 of the mounting flange 214; and the tabs 280 extend from the collar 276 in the same general horizontal direction and orientation as the exterior surfaces 231 and 233 of the mounting flange 214.

In the embodiment shown, the mounting insert 270 is insert molded into the plastic material of the mounting flange 214 in a relationship and orientation wherein the radial end face of the base or sleeve 282 without the collar 276 is located opposed and abutting against the exterior surface of the vehicle pedal assembly mounting bracket 23 when the pedal assembly housing 212 is mounted and secured to the mounting bracket 23.

The mounting screws 21 are threaded successively into respective through-holes 27 (FIG. 11) defined in the mounting bracket 23 and then into the respective through-holes defined in the respective mounting inserts 270 insert molded into the respective mounting flanges 214 in the same manner as described above with respect to the pedal assembly 10 and thus incorporated herein by reference for mounting and securing the pedal assembly housing 212 to the mounting bracket 23.

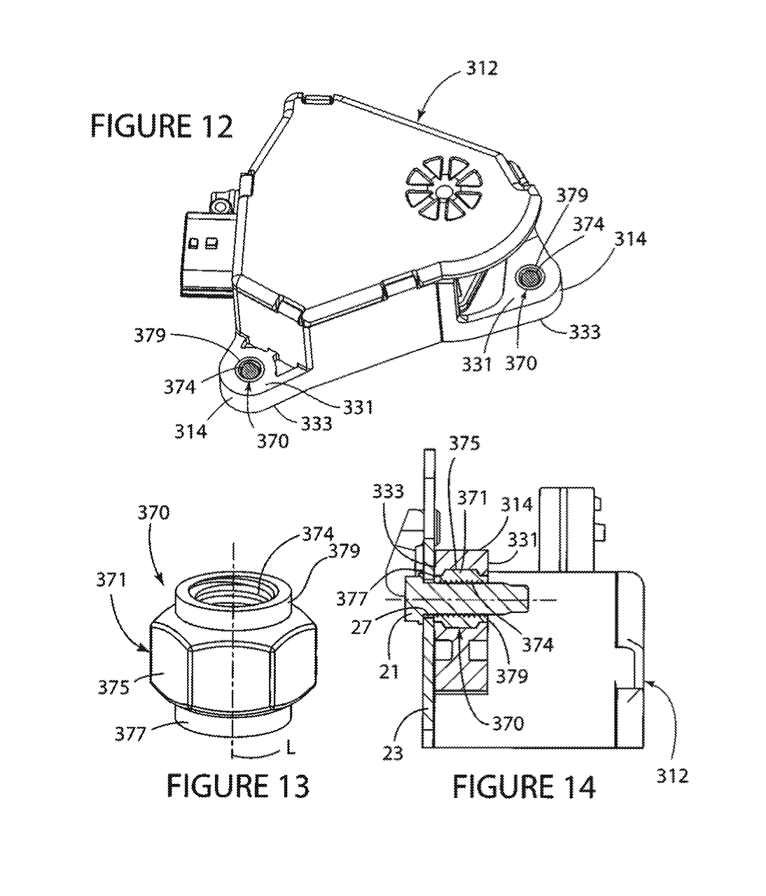

FIGS. 12-14 depict a vehicle pedal assembly housing 312 with another embodiment of a hex nut type mounting insert 370 in accordance with the present invention.

The pedal assembly housing 112 is identical in structure to the pedal assembly housing 12 with the exception of the structure of the mounting inserts 370 and is adapted to be mounted and secured to the pedal assembly mounting bracket 23 in the same manner as the pedal assembly housing 12 and thus the earlier description of the elements of the pedal assembly housing 12, the pedal assembly 10, and the mounting bracket 23 is incorporated herein by reference with respect to the pedal assembly housing 112.

Specifically, the pedal assembly housing 312 comprises a housing for the pedal 13 and includes a plurality of outwardly protruding mounting flanges or arms 314. The mounting insert 370 is located and secured in each of the mounting flanges 314 in the same manner as described above with respect to the mounting insert 70, the description of which is thus incorporated herein by reference and specifically as by, for example, insert molding into the plastic material defining each of the mounting flanges 314 during the molding operation that is used during the manufacturing operation to form the pedal assembly housing 312 and more specifically the respective mounting flanges 314 of the pedal assembly housing 312.

As shown in more detail in FIG. 13, the mounting insert 370, which is preferably made of a suitable metal material including for example a steel, Zinc, and Chrome alloy, is in the form of a hex nut 371 that includes a hexagonally shaped exterior circumferential surface 375 and a threaded interior circumferential surface 374 that defines a through-hole extending through the interior of the hex nut 371 and defines respective openings in the opposite ends of the nut 371.

A pair of generally cylindrically shaped central and interiorly threaded collars 377 and 379 protrude unitarily outwardly from the respective radial distal end faces of the nut 371 and extend in a relationship generally parallel and spaced from the longitudinal axis L of the nut 371. The collar 377 surrounds the opening defined in the one end of the nut 371 and the collar 379 surrounds the opening defined in the opposite end of the nut 371.

Each of the mounting inserts 370 is insert molded into the plastic material of each of the respective mounting flanges 314 of the pedal housing 312 into a position and relationship in each of the respective mounting flanges 314 as shown in FIG. 14 wherein: the hex nut 371 extends through the interior of the flange 314 in a relationship wherein the longitudinal axis L thereof is oriented in a relationship and orientation generally normal to the opposed exterior surfaces 331 and 333 of the respective mounting flanges 314; the peripheral exterior radial end face of the collar 379 is even or flush with the exterior surface 331 of the mounting flange 314; and the peripheral exterior radial end face of the collar 377 is even or flush with the opposed exterior surface 333 of the mounting flange 314.

The mounting screws 21 are threaded successively into respective through-holes 27 (FIG. 14) defined in the mounting bracket 23 and then into the respective through-holes defined in the respective mounting inserts 370 insert molded into the respective mounting flanges 314 in the same manner as described above with respect to the pedal assembly 10 and thus incorporated herein by reference for mounting and securing the pedal assembly housing 312 to the mounting bracket 23.

Numerous variations and modifications of the embodiments described above may be effected without departing from the spirit and scope of the novel features of the invention. It is to be understood that no limitations with respect to the pedal assembly and mounting inserts illustrated herein are intended or should be inferred. It is, of course, intended to cover by the appended claims all such modifications as fall within the scope of the claims.

What is claimed is:

1. A vehicle pedal assembly comprising a housing for a pedal made of a molded plastic material, the housing including a mounting flange with a nut type mounting insert that has been insert molded into the plastic material of the mounting flange.

2. The vehicle pedal assembly of claim 1 wherein the mounting insert is a T-nut type mounting insert including an interiorly threaded elongate sleeve and a radial collar with a plurality of tabs.

3. The vehicle pedal assembly of claim 2 wherein the plurality of tabs depend downwardly from the radial collar in a relationship spaced and generally parallel to the sleeve and the longitudinal axis of the mounting insert and terminate in a rounded distal barb.

4. The vehicle pedal assembly of claim 2 wherein the plurality of tabs depend downwardly from the radial collar in a relationship spaced and generally parallel to the sleeve and the longitudinal axis of the mounting insert and terminate in an arrow-shaped distal barb,

5. The vehicle pedal assembly of claim 2 wherein the mounting insert is a slotted flange type nut wherein the radial collar includes a plurality of tabs and slots extending around the sleeve of the mounting insert in an alternating relationship.

6. The vehicle pedal assembly of claim 1 wherein the mounting insert is a hex nut type mounting insert wherein the sleeve of the mounting insert is in the form of an interiorly threaded hex nut including first and second interiorly threaded collars extending outwardly from the respective distal end faces of the hex nut.

7. A vehicle pedal assembly comprising a pedal housing made of a molded plastic material and including a mounting flange with a mounting insert, the mounting insert including a threaded sleeve extending into the mounting flange and a radial collar on the sleeve with a plurality of elongate tabs extending into the mounting flange for securing the mounting insert to the mounting flange of the pedal housing.

8. The vehicle pedal assembly of claim 7 wherein the mounting insert is insert molded into the plastic material of the mounting flange, the plurality of tabs extending downwardly from the collar in a relationship spaced and parallel to the sleeve and the longitudinal axis of the mounting insert and terminating in a rounded distal barb.

9. The vehicle pedal assembly of claim 7 wherein the mounting flange of the pedal housing defines a through-hole, a recess surrounding the through-hole, and a plurality of slots surrounding and spaced from the through-hole and extending in a direction normal to the opposed exterior surfaces of the mounting flange, the sleeve and the collar and the plurality of tabs of the mounting insert being press-fitted into the respective through-hole and the recess and the plurality of slots respectively in the mounting flange of the pedal housing for securing the mounting insert in the mounting flange of the pedal housing.

10. The vehicle pedal assembly of claim 9 wherein the plurality of tabs extend downwardly from the collar of the mounting insert in a relationship spaced and parallel to the sleeve and the longitudinal axis of the mounting insert and terminate in an arrow-shaped distal barb that is press-fitted into a slot defined in the mounting insert.
